(19) United States
(12) Patent Application Publication
(10) Pub. No.: US 2004/0008875 A1
(43) Pub. Date: Jan. 15, 2004

(54) 3-D fingerprint identification system

(76) Inventor: Miguel Linares, Bloomfields Hills, MI (US)

Correspondence Address: Sonya C. Harris, PO Box 2607, Fairfax, VA, 22031, US

(21) Appl. No.: 10/190,739

(22) Filed: Jul. 9, 2002

(51) Int. Cl. G06K 9/00

(52) U.S. Cl. 382/124

(57) ABSTRACT

The present invention features a three-dimensional fingerprint based personal identification system. This system is designed to provide a unique three-dimensional map of the finger of an individual which is placed in contact with a transparent surface, and link it to his/her other personal details. This 3-D fingerprint identification system consists of three major components for operation. The first component comprises the fingerprint image acquisition hardware. The second component comprises the pattern storage and matching software. The third component of the present invention comprises the database storage and retrieval system.

### BACKGROUND OF THE INVENTION

1. Field of the Invention

The present invention generally relates to fingerprint verification systems and methods and, more particularly, to a system and method for obtaining 3-dimensional information of human fingerprints.

2. Discussion of the Prior Art

The U.S. patent to Takhar et al (U.S. Pat. No. 6,002,787), directed to a Fingerprint Analyzing and Encoding System, teaches of a system for converting an image-enhanced digitized raster fingerprint image to vector lines in order to generate an identification value for the fingerprint. The raster image pixels are converted to vector lines along the fingerprint ridges and the vector lines are classified and converted according to type. The line types are then analyzed and a list of identification features corresponding the the vector line types is genereated. The identification features between vector line types are compared and the image is classified according to fingerprint class. An identification value is then generated by numerically encoding the classified identification features. All of the classification means is based upon two-dimensional information.

The U.S. patent to Scott et al (U.S. Pat. No. 6,111,977) of a Hand-held Fingerprint Recognition and Transmission Device stresses portability. A portable fingerprint recognition transmitter operates to take an image of a fingerprint and transmits the fingerprint image via infrared or radio frequency to a receiver having previously stored fingerprint images for comparison. The system is described as a closed circuit system using stored images for the purposes of unlocking a security area. This device employs two-dimensional scanning to produce the image used for comparison.

Ross (U.S. Pat. No. 6,195,447) discloses a System and Method for Fingerprint Data Verification. The disclosure teaches of a system and method for authenticating fingerprints remotely with a scanner for generating fingerprint data. A local site connects to the remote site via transmission cables and includes a processor for extracting minutia for the fingerprint data. A comparator matches the fingerpront data to historical fingerprint data maintained in a database to verify whether the detected fingerprint data falls within statistical maximum deviations to establish the authenticity of the fingerprint.

The U.S. patent to Gagne et al (U.S. Pat. No. 6,212,290) directed toward a Non-Minutiae Automatic Fingerprint Indentification System and Methods teaches of a system for verifying a person's identity. The image of a finerprint of a person to be identified is provided on a lens means, which when touched by a finger of the person causes immediate development of an image of the fingerprint of the finger in a black and white appearance. This image of the fingerprint is video scanned to produce image data which is digitized to produce a non-minutiae numerical identifier indicative of the fingerprint. The non-minutiae digitized numerical identifier is provided by selectively analysing different parts of a fingerprint and deriving from each part a byte numeric which is directly related to ridge count for that particular section. The scanning is two-dimensional.

None of these patents either teaches or suggests a means for scanninging three-dimensional fingerprint data which can process the design of the fingerprint including, but not limited to, the distance between each line, and also the depth surface of lines of each fingerprint.

It is therefore an object of the invention to provided a system and method for obtaining three-dimensional data of a fingerprint.

It is another object of the invention to provide a system and method for obtaining three-dimensional fingerprint data consisting of the distance between each line, and also the depth surface of lines of each fingerprint.

It is also an object of the invention to provide a system and method for obtaining three-dimensional data of a fingerprint that employs laser scanning technology to scan a three-dimensional image of a finger.

It is a further object of the invention to provide system and method for obtaining three-dimensional data of a fingerprint employing pattern storage and matching software to file and/or match scanned three-dimensional fingerprint images with a pre-stored fingerprint pattern for personal indentification.

It is an additional object of the invention to provide a system and method for obtaining three-dimensional data of a fingerprint that employs personal database storage and retrieval of a scanned three-dimensional fingerprint image and other personal data.

It is a still further object of the invention to provide a system and method for obtaining three-dimensional data of a fingerprint employing image processing means for digitizing and translating the fingerprint images.

### SUMMARY OF THE INVENTION

The present invention features a three-dimensional fingerprint based personal identification system. This system is designed to provide a unique three-dimensional map of the finger of an individual, which is placed in contact with a transparent surface, and link it to his/her other personal details. This 3-D fingerprint identification system consists of three major components for operation. The first component comprises the fingerprint image acquisition hardware. The second component comprises the pattern storage and matching software. The third component of the present invention comprises the database storage and retrieval system.

### BRIEF DESCRIPTION OF THE DRAWINGS

A complete understanding of the present invention may be obtained by reference to the accompanying drawings, when taken in conjunction with the detail description thereof and in which:

FIG. 1 is a diagrammatic view of the components of the 3-D fingerprint identification system.

FIG. 2 is a flowchart of operation of the 3-D fingerprint identification system.

FIG. 3 is a diagrammatic view of the Fingerprint Image Acquisition Hardware in accordance with the present invention.

FIG. 4 is an illustration of fingerprint patterns.

FIG. 5a is plan view of an exemplary scanned fingerprint.

FIG. 5b is a cross section of the exemplary scanned fingerprint of FIG. 5a.

### DESCRIPTION OF THE PREFERRED EMBODIMENT

In the following detailed description of the preferred embodiments, reference is made to the accompanying drawings which form a part hereof, and in which is shown by way of illustration, specific embodiments in which the invention may be practiced. It is to be understood that other embodiments may be utilized and structural changes may be made without departing from the scope of the present invention.

This disclosure of the invention is submitted in furtherance of the constitutional purposes of the U.S. patent Laws “to promote the progress of science and useful arts” (Article 1, Section 8).

As previously described, the present invention relates to a system for obtaining a laser-scanned digitized fingerprint image in order to generate a database of stored fingerprints for subsequent identification of an individual. The system performs stereoscopic scanning of a finger to develop a unique three-dimensional map of the finger of an individual which can thereby be linked to his/her personal details. It will be recognized that the present invention may be used in numerous other applications without loss of generality. The present invention is described hereinbelow in the application regarding security and personal identification utilities.

The basic fundamentals in the science of fingerprint identification are permanence and individuality. Fingerprints ridges are formed during the third to fourth month of fetal development. These ridges consist of individual characteristics called ridge endings, bifurcations, dots and many ridge shape variances. The unit relationship of individual characteristics doesn't not naturally change throughout life. Unnatural changes to fingerprint ridges include deep cuts or injuries penetrating all layers of the epidermis and some diseases such as leprosy.

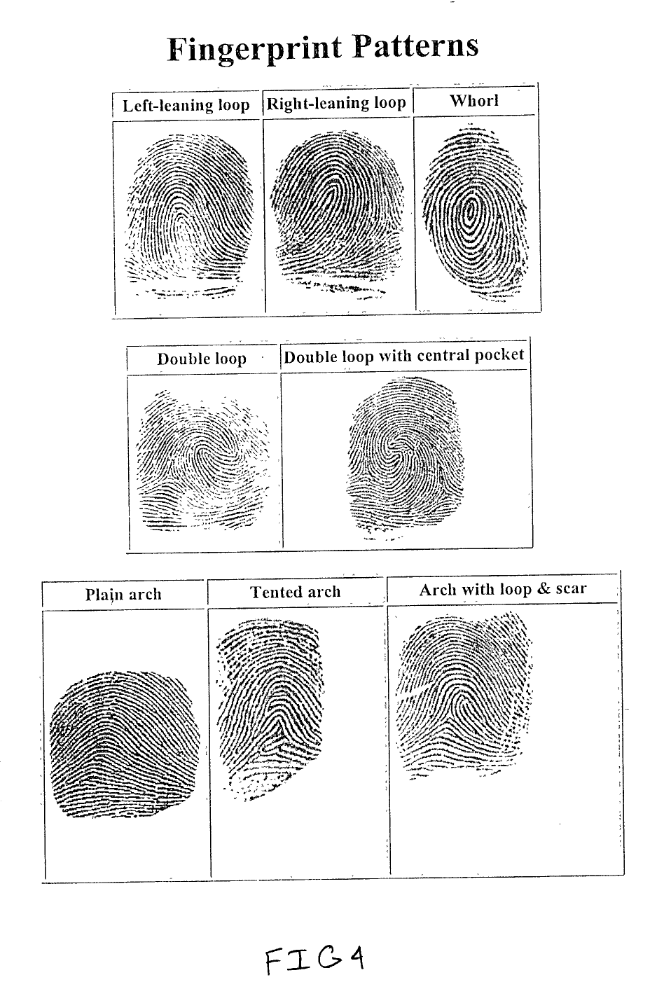

In the over 140 years that fingerprints have been routinely compared worldwide, no two fingerprints on any two persons (including twins) have been found to contain the same individual characteristics in the same unit relationship. This means that in general, even with an area the measure of a few millimeters wide, the fingerprints of one person will contain sufficient individual characteristics in a unique unit relationship to enable positive identification to the absolute exclusion of any other person on earth. Fingerprint patterns comprise class characteristics such as loop, arch formations, whorl ridge patterns, ridge counts and tracings between different pattern focal points (deltas and cores) for the purposes of identification. Examples of different types of fingerprint patterns are shown in FIG. 4. The present invention is based on dactyloscopy, i.e., the practice of using fingerprints to identify individuals.

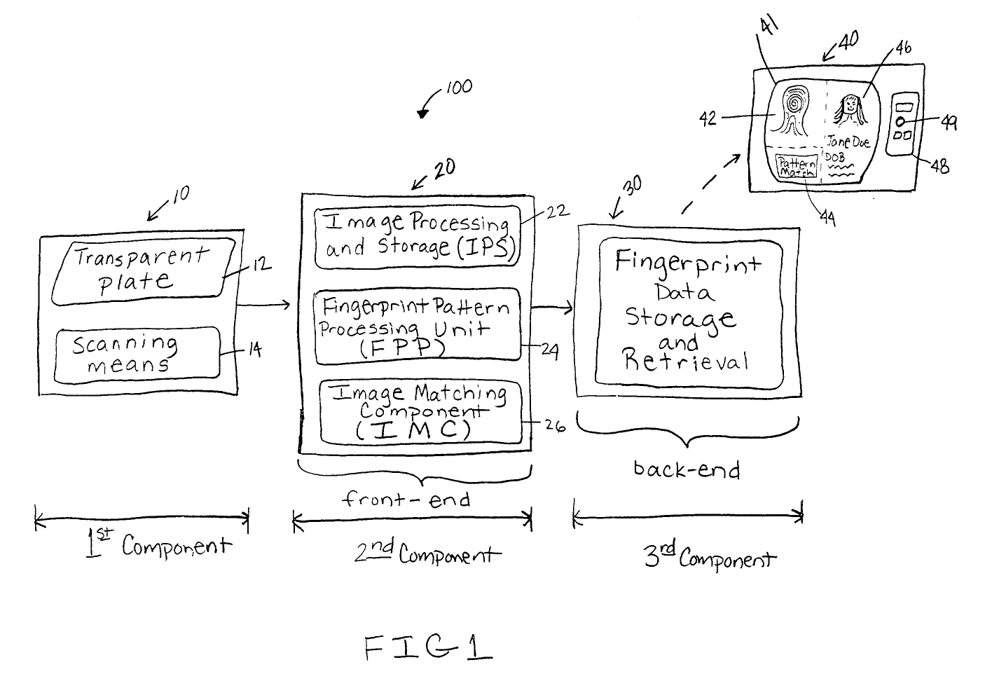

In operation, the three-dimensional fingerprint identification system 100, in accordance with the present invention, consists of three major components for operation, as illustrated diagrammatically in FIG. 1. The first component comprises the fingerprint image acquisition hardware (FIAH) 10. The second component comprises the fingerprint processing software 20. The third component of the present invention comprises the database management sub-system 30.

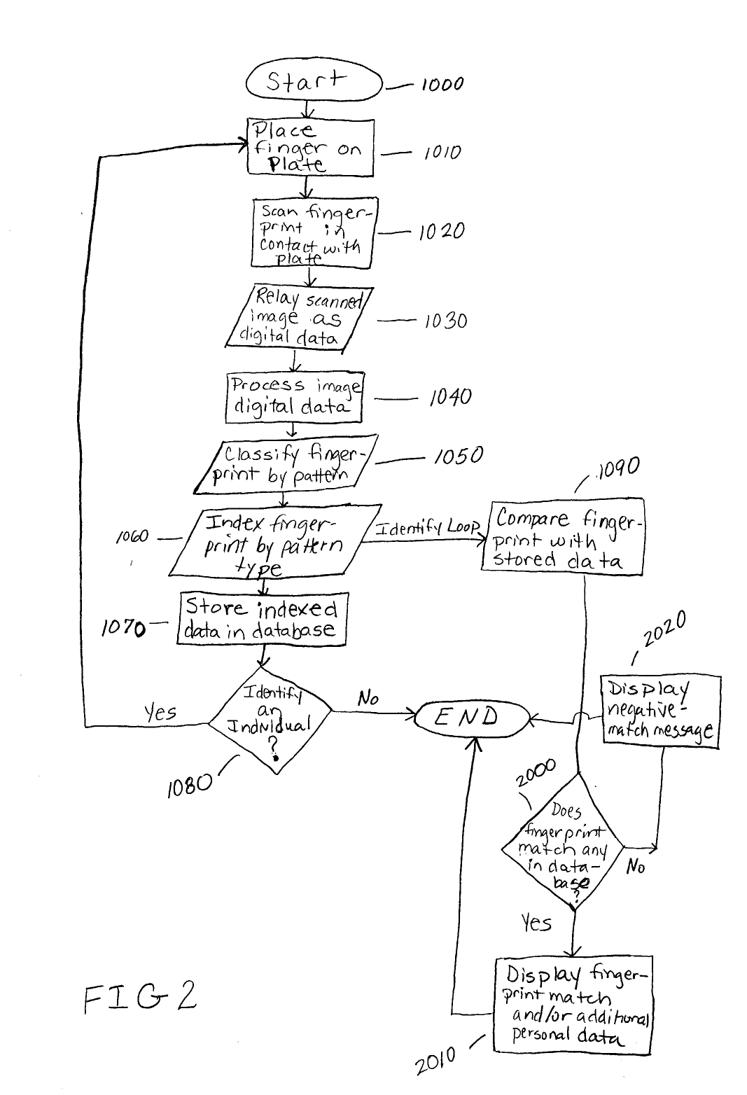

FIG. 2 is a flow chart showing the operation of the fingerprint identification system 100. Steps 1010 through 1030 illustrate operations of the first component, the FIAH 10. The steps associated with the operation of the FIAH, include placing the finger on the plate 1010; scanning the fingerprint in contact with the plate 1020; and relaying the scanned image as digital data 1030. Steps 1040-1060 and 1090-2000 indicate operation steps performed by the second component, the fingerprint processing software 20. These steps associated with the operation of the fingerprint processing software 20 include processing the image digital data 1040; classifying the fingerprint pattern 1050; and indexing the fingerprint by pattern type 1060. Step 1070, storing the indexed data in the database, is representative of the operation performed via the database management sub-system 30. However, once an individual approaches the system for identification, as shown by 1080, the fingerprint is compared with fingerprint data stored in the database 1090 to determine if a match exists therein 2000. This manipulation is done by the fingerprint software system 20. If a match is found within the database then the fingerprint match and/or the additional information about the individual is displayed 2010 via display means 40. Or, if no match is found in the database, a message indicating such is displayed 2020 by display means 40. Each of the components will be described in further detail hereinbelow.

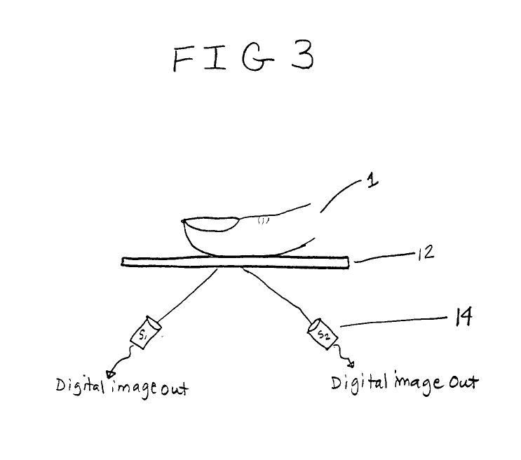

In a preferred embodiment, the FIAH 10 employs stereoscopic laser imaging to acquire a three-dimensional fingerprint image. The hardware used consists of a laser scanning means 14 deployed beneath a clear, flat plate 12 (FIG. 3). The clear plate 12 can be any suitable transparant glass plate such as those commonly used in the well known flatbed or desktop scanners. A finger or the thumb 1 is placed in direct contact with the plate 12 for fingerprint image capture.

Beneath the plate is the laser scanning means 14. The laser scanning means 14, as shown in FIG. 3, consists of two independent laser beams from two laser sources S1 and S2 which scan the patterns of the fingerprints. Each laser is programmed to scan pre-determined cross sections of the finger 1 and thus obtaining two independent digital images of the same finger. These two images when superimposed would be able to generate a stereoscopic three dimensional image of the finger 1 that would not only contain the information about the physical location of the fingerprint patterns but also the information about the depth of each furrow of the finger 1. This stereoscopic image will be processed by the fingerprint processing software 20, and then subsequently stored in a database 30 along with other relevant information about the individual (e.g., photograph, etc.), depending upon the application.

The fingerprint processing software 20 may be a specific front-end software based on client-server technology. This software is bound to the FIAH 10 and may employ specific drivers for acquiring images from the FIAH 10. The software may be Windows™ based and may employ specific drivers for acquiring images from the scanning software. The software preferably consists of three specific components comprising the Image Processing and Storage component (IPS) 22, the Fingerprint Pattern Processing unit (FPP) 24, and the Image Matching Component (IMC) 26.

The IPS 22 comprises an image processor that interfaces with the FIAH 10 hardware component and acquires the stereoscopic image of the fingerprint. The IPS 22, gathers the digital image data provided by the laser scanning and translates the acquired images into bitmaps. The bit maps will then make use of the digitized information by translating it into an image-representation consisting of rows and columns of dots. The bit maps are then compressed for efficient storage and use via the IPS 22. These bit maps of the fingerprint patterns may further be translated into pixels for visual output on a display means 40 along with other accompanying information about the individual.

The display means 40, may be a video monitor, a television screen, a closed circuit TV (CCTV), or the like. The display means 40 may comprise a multi-segmented display screen 41 for displaying, for example, the fingerprint image 42, an accompanying picture of the individual including text of a personal data 46, and textual messaging 44. Control panel 48 may include input keys 49 for scrolling through further information.

The fingerprint processing software 20 comprises a Fingerprint Pattern Processing unit (FPP) 24 that performs the functions of:

1) analyzing,

2) classifying, and

3) indexing the fingerprint patterns.

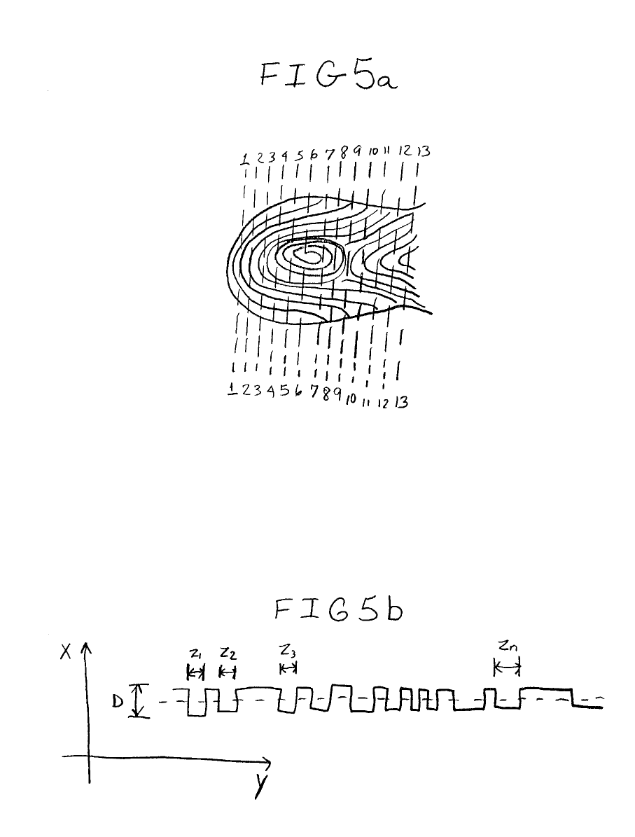

FIG. 5a illustrates scan lines of the laser scanning means 14. Each laser source S1 and S2 scans across the finger 1 in contact with plate 12 along scan lines 1-1, 2-2, 3-3, and so on. FIG. 5b is a pictorial translation of the scanned image data of each of the scan lines providing information regarding the depth of the furrows of the fingerprint, D, on the x-axis; and the distance between the furrows Z1, Z2, etc., on the y-axis. It is this translated fingerprint pattern image data that is processed by the FPP 24 into usable data.

The Image Matching Component, (IMC) 26 is configured to interface with the database management sub-system 30 for matching the fingerprint images with previously stored images. These components are then matched with the image components stored in the back-end database management sub-system 30 utilizing efficient searching and sorting algorithms. Once a match is found, the component provides accompanying information stored in the back-end database management sub-system 30 regarding the particular individual so identified and display it on the visual output display means 40. The information can be “layered” so that only minimum relevant information is displayed by default and further information is displayed upon prompting by a user with the user interfacing with control panel 48 of display means 40, or alternatively via other input means (not shown).

The fingerprint pattern is then dispatched for storage on the back-end database management system 30 (described in detail below). In addition to the stereoscopic image, the IPS 22 component is designed to accept further information about the individual from input devices such as, but not limited to, a keyboard or a simple graphic scanner (not shown). The entire information acquired may be sent to the back-end database engine for storage in a normalized database. The system 100 may be back-end independent and able to interface with standard database engines like ORACLE™, Sybase™, Access™, SQL-Server™, etc.

As for the database management sub-system 30, it will employ a standard and tested back-end database management scheme to store and retrieve the individual information. The relevant information to be managed by the database management sub-system 30 includes:

1) the stereoscopic fingerprint image

2) the digitized identifiable components of the 3-D image; and

3) relevant information about the individual.

However, the front-end software will be independent of the back-end engine employed as in any typical client/server application.

Since other modifications and changes varied to fit a particular operating requirements and environment will be apparent to those skilled in the art, the invention is not considered limited to the example chosen for purposes of disclosure, and covers all changes and modifications which do not constitute a departure from the true spirit and scope of the invention.

For example, the FIAH 10 may comprise video scanning in lieu of laser scanning technology. In the instant of video scanning, a further image processing step of converting the image from analog to digital form may be performed. Analog cameras (non-digital) may be used to capture the image of the cards. These may include video recording cameras. Herein, an analogue-to-digital converter may be used to simplify the image data for display output. Any suitable camera or camera-type device known in the art may be used to capture the image of the fingerprint.

Or, alternatively, a digital camera (not shown) may be used to acquire the image of the fingerprint. It is well known to those in the art that digital cameras utilize CMOS (complementary metal-oxide semiconductor) technology. Herein, CMOS chips have an advantage of using low power requirements. In addition, the CMOS sensor can be loaded with a host of other tasks that can be translated to the operation of the IPS 22 component, such as analogue to digital converting, load signal processing, handling white balance and more camera controls. For example, CMOS chips are high resolution sensors with space efficiency capability enabling sensor designs with the possibility of increasing density and bit depth without significant cost increases.

A digital video camera (DV camera), not shown, may also be employed to capture digital video images, thereby reducing steps of video microprocessing. The output of a DV camera is already in compressed, digital format. Therefore, all that is needed is to transfer the acquired fingerprint images straight from the camera for post capture processing.

Any suitable means for capturing image data known in the art, such as, but not limited to, lenses, mirrors, fiber optics, fiber optical transmission tubes, optical sensor arrays, photosensitive diodes and/or any combinations thereof may be used to capture the photonic information and relayed to any choice of camera means to thereby obtain an image of the finger in contact with the plate.

Having thus described the invention, what is desired to be protected by Letters Patent is presented in the subsequent appended claims.

What is claimed is:

1. A three-dimensional fingerprint indentification system comprising:
a) fingerprint acquisition means for capturing a stereoscopic fingerprint image,
b) fingerprint processing means, operatively connected to said fingerprint acquisition means, for processing the captured fingerprint image as digital data,
c) a database management sub-system for storage and retrieval of said digital data.

2. A three-dimensional fingerprint identification system as in claim 1 wherein,
said fingerprint image acquisition means comprises transparent plate and
laser scanning means for obtaining a fingerprint image by optically scanning a finger placed in contact with said plate;
and wherein said transparent plate and said laser scanning means are in optical communication such that the digital data is directly relayed via the laser scanning means to the fingerprint processing means.

3. A three-dimensional fingerprint identification system as in claim 2 wherein,
said laser scanning means comprises at least two laser sources,
said at least two laser sources positioned such that each laser scans sections of a finger placed in contact with the transparent plate in a sweeping manner producing sections with overlapping scan lines, said overlapping sections providing stereoscopic images.

4. A three-dimensional fingerprint identification system as in claim 3 wherein,
said fingerprint processing means comprises an image processor and fingerprint processing software configured to interface with said image processor to thereby analyze, classify and index said captured fingerprint image.

5. A three-dimensional fingerprint identification system as in claim 4 wherein,
said system is a client-server configuration with said fingerprint processing software being front-end and said database management sub-system being back-end.

6. A three-dimensional fingerprint identification system as in claim 1 wherein,
said image processor is configured to:
a) map the image data for bit map formatting,
b) compress the image data, and
c) store said image data.

7. A three-dimensional fingerprint identification system as in claim 6 further comprising visual output means for displaying information of an individual; and
wherein said image processor is further configured to convert said bit map images into pixels for display of said bit map images as fingerprints on said visual output means in conjunction with said displayed individual information.

8. A three-dimensional fingerprint identification system as in claim 7 wherein,
said visual output means comprises visual means in the group consisting of a monitor, a television screen, and a closed circuit TV.

9. A three-dimensional fingerprint identification system as in claim 2 wherein,
said fingerprint image acquisition means comprises video scanning means.

10. A three-dimensional fingerprint identification system as in claim 9 wherein,
said fingerprint processing means further comprises an image processor and fingerprint processing software configured to interface with said image processor to thereby analyze, classify and index said captured fingerprint image.

11. A three-dimensional fingerprint identification system, as in claim 10, wherein
said image processor is configured to:
a) map the image data for bit map formatting,
b) compress the image data, and
c) store said image data.

12. A three-dimensional fingerprint identification system, as in claim 10, wherein said fingerprint processing means further comprises an image processor having an analog-to-digital converter.

13. A method for obtaining and processing a three-dimensional fingerprint, said method comprising the steps of:
a) providing a three-dimensional fingerprint system having fingerprint acquisition means for capturing a fingerprint image, said fingerprint acquisition means consisting of a transparent plate;
fingerprint processing means, operatively connected to said fingerprint acquisition means, for processing the captured fingerprint image as digital data
a database management sub-system for storage and retrieval of said digital data;
b) placing a finger in contact with said transparent plate,
c) scanning a finger in contact with said transparent plate to produce a stereoscopic fingerprint image,
d) processing said fingerprint image as digital data via the image processor of said fingerprint processing means,
e) storing said digital data in said database management sub-system.

14. The method of obtaining and processing a three-dimensional fingerprint, as in claim 13 wherein,
said scanning step includes providing laser scanning means having at least two laser sources for capturing a stereoscopic fingerprint image, and positioning said laser sources in a predetermined manner such that each laser scans sections of a finger placed in contact with the transparent plate in a sweeping manner producing sections with overlapping scan lines, said overlapping sections thereby producing said stereoscopic image.

15. The method of obtaining and processing a three-dimensional fingerprint, as in claim 14 wherein,
said processing step includes
a) mapping the image data for bit map formatting,
b) compressing the image data, and
c) storing said compressed data
with said image processor.
